(19) United States
(12) Patent Application Publication
(10) Pub. No.: US 2013/0305814 A1
(43) Pub. Date: Nov. 21, 2013

(54) DEVICE AND METHOD FOR MEASURING THE AIR PERMEABILITY OF A BUILDING

(71) Applicants: Ludivine Menez, Paris (FR); Vincent Hannecart, Asnieres Sur Seine (FR); Christophe Jeudi, Chance (FR); Eric Bourasseau, Plechatel (FR); Christian Bouvet, St Senoux (FR); Antoine Cerisier, Gibourne (FR)

(72) Inventors: Ludivine Menez, Paris (FR); Vincent Hannecart, Asnieres Sur Seine (FR); Christophe Jeudi, Chance (FR); Eric Bourasseau, Plechatel (FR); Christian Bouvet, St Senoux (FR); Antoine Cerisier, Gibourne (FR)

(73) Assignees: UBAT CONTROLE, Bain de Bretagne (FR); SAINT-GOBAIN ISOVER, Courbevoie (FR)

(21) Appl. No.: 13/988,883

(22) PCT Filed: Nov. 22, 2011
(86) PCT No.: PCT/FR11/52731

§ 371 Date: Aug. 1, 2013

(30) Foreign Application Priority Data
Nov. 22, 2010 (FR) 10 04539
Nov. 23, 2010 (FR) 10 59648

(51) Int. Cl. G01N 15/08

(52) U.S. Cl. CPC G01N 15/0826
USPC 73/38

(57) ABSTRACT

A device measuring air permeability of a building, including: an airtight duct, open at both its ends; a motorized fan; an air induction member positioned in the duct with its axis of rotation substantially parallel to a longitudinal axis of the duct; a mechanism measuring pressure difference between an inside of a part of the building and an outside of the building; an adjustable shut-off member shutting off the duct, and configured to vary locally cross section for air flow through the duct, the shut-off member being continuously adjustable between a configuration of minimal shutting-off of the duct and a configuration of complete shutting-off of the duct; and a mechanism determining a degree to which the duct is shut off by the shut-off member for a reference pressure difference determining, from the degree of shutting-off, either corresponding air flow rate through the duct, or a parameter representative of the air permeability.

The present invention relates to a device and a method for measuring the air permeability of all or part of a building.

In order to be able to evaluate the extent to which a building complies with a fixed airtightness specification, it is known practice for the air permeability of the building to be measured by mechanically pressurizing or depressurizing the building and by measuring the air flow rates that result from this in a range of static pressure differences between the inside and the outside of the building. Parameters representative of the air permeability of the building can then be calculated from the results of the pressurization or depressurization test, such as, for example, the leakage flow rate at 4 Pa divided by the cold wall surface area, denoted Q_{4Pa-surf}, which is notably used for the BBC-Effinergie label, or the leakage flow rate at 50 Pa divided by the heated volume, denoted n₅₀, which is notably used for the Passivhaus or Minergie-P labels.

In order to achieve maximum precision on the calculated permeability parameter, measurements of the air flow rate and the pressure difference are taken over a range of pressure differences applied in steps of at most 10 Pa, where the highest pressure difference has to be at least 50 Pa. Because of these multiple measurements, the method is lengthy and difficult to implement. Taking multiple measurements and exploiting them to calculate a permeability parameter require unwieldy and costly equipment, involving electronic measurement and computation equipment.

In particular, a device conventionally used by the certified organizations to measure the air permeability of a building is the blower door device comprising a false door which is connected to a fan and can be fitted to the standard door or window openings. In this device, the fan is provided with a variable speed motor, so that it can cover the range of necessary flow rates. The device also comprises electronic measurement equipment which is connected to a computer designed to calculate permeability parameters from the measured values. This known device is unwieldy, cumbersome and difficult for a single operator to install. In addition, because it involves numerous pieces of electronic equipment, including the speed variator for the motor, the measurement equipment and the computer, this device is fragile, making it awkward to use on site.

It is these disadvantages that the invention intends more particularly to remedy by proposing a device that allows the air permeability of a building or part of a building to be evaluated simply and quickly, this device being both robust and lightweight. There is a need for such a device that is simple to use and less expensive than the existing devices, particularly so that the companies responsible for achieving airtightness can perform their own self-checks on site. The purpose of these self-checks is notably to check, prior to official validation by a certified organization, that the construction is overall compliant with thresholds required in terms of airtightness.

To this end, one subject of the invention is a device for measuring the air permeability of at least a part of a building, comprising:
an airtight duct, open at both its ends, a first end of the duct being intended to open to the inside of the part of the building while the second end of the duct is intended to open to the outside of the building,
a motorized fan, a rotary air induction member of which is positioned in the duct with its axis of rotation substantially parallel to the longitudinal axis of the duct,
means for measuring the pressure difference between the inside of the part of the building and the outside of the building,
   characterized in that it further comprises:
an adjustable shut-off member for shutting off the duct, which member is capable of varying locally the cross section for air flow through the duct, this shut-off member being continuously adjustable between a configuration of minimal shutting-off of the duct and a configuration in which the duct is completely shut off, and
means for determining the degree to which the duct is shut off by the shut-off member for a reference pressure difference and means for determining, from this degree of shutting-off for the reference pressure difference, either the corresponding air flow rate through the duct, or a parameter representative of the air permeability of the part of the building.

According to other advantageous features of a device according to the invention, considered in isolation or in any technically feasible combinations:
the shut-off member is capable of varying locally the cross section for air flow through the duct upstream of the air induction member of the motorized fan;
the shut-off member is capable of varying locally the cross section for air flow through the duct downstream of the air induction member of the motorized fan;
the means for determining the degree to which the duct is shut off for the reference pressure difference are visual means or equivalent means, notably means comprising, on the outside of the duct, a slider moving past a graduation as the shut-off member is being adjusted, or means comprising an electronic sensor for measuring the degree of shutting-off, that is arranged in the duct, particularly an electronic angle sensor when the shut-off member is a pivoting flap; in the case of visual means of the slider type moving past a graduation, the slider may, in particular, be formed by an operating knob for operating the shut-off member between the configuration of minimal shutting-off and the configuration of complete shutting-off, this knob moving, upon adjustment, past a graduation;
the means for determining, from the degree of shutting-off for the reference pressure difference, the air flow rate in the duct or a parameter representative of the air permeability, are advantageously means of direct determination which establish a direct correspondence between the degree of shutting-off, on the one hand, and the air flow rate or the air permeability parameter, on the other hand, notably a chart or a correlation table, or else a database providing a correspondence between the degree of shutting-off, on the one hand, and the air flow rate or air permeability parameter, on the other hand, which can be preprogrammed into a computer;
the device comprises means for determining a parameter representative of the air permeability of the part of the building from the degree of shutting-off for the reference pressure difference, which are visual means comprising at least one chart which, for the reference pressure difference, establishes a relationship between the degree to which the duct is shut off by the shut-off member, a dimension characteristic of the part of the building, and a parameter representative of the air permeability of the part of the building;
the device comprises means for determining the air flow rate from the degree of shutting-off for the reference pressure difference, and means for calculating a parameter representative of the air permeability of the part of the building from the air flow rate;
the device comprises means for determining the air flow rate from the degree of shutting-off for the reference pressure difference, which are visual means comprising at least one chart which, for the reference pressure difference, establishes a relationship between the degree to which the duct is shut off by the shut-off member and the air flow rate through the duct;
the shut-off member is capable of varying locally the cross section for air flow through the duct symmetrically with respect to the axis of rotation of the air induction member of the motorized fan;
the shut-off member is a pivoting flap placed in the duct and able to pivot about an axis that is transverse to the longitudinal axis of the duct, between a position of minimal shutting-off of the duct and a position of complete shutting-off of the duct;
in the position of minimal shutting-off of the duct, the pivoting flap is oriented substantially parallel to the longitudinal axis of the duct, while in the position of complete shutting-off of the duct, the pivoting flap is oriented transversely with respect to the longitudinal axis of the duct;
the device comprises a knob for operating the pivoting flap between the position of minimal shutting-off and the position of complete shutting-off, this knob being secured to the pivot axis of the pivoting flap;
the shut-off member is a diaphragm of adjustable cross section arranged in the duct with the central axis of the diaphragm substantially parallel to the longitudinal axis of the duct;
the motorized fan has no electronic speed variator;
the means for measuring the pressure difference comprise a differential pressure gauge to which are connected two air intake pipes, one for air intake inside the part of the building and the other for air intake outside the building;
the device comprises a panel that can be fixed, airtightly and removably, into an opening of the part of the building which opens to the outside of the building, this panel comprising a sleeve through which the duct passes;
the device comprises means of airtight cooperation between the sleeve and the duct, comprising an elastic of the sleeve that can be housed in an external peripheral groove of the duct;
the device comprises means for holding two air intake pipes, belonging to the pressure difference measurement means, on each side of the external peripheral groove of the duct;
the device comprises a frame for the airtight and removable attachment of the panel into an opening of the part of the building, the frame being made up of a plurality of section pieces that can be joined together reversibly;
the device comprises a chassis for supporting the duct and means for measuring the pressure difference, this chassis being fitted with wheels.

Another subject of the invention is a method for measuring the air permeability of at least a part of a building using a device as described hereinabove, comprising successive steps in which:
the duct is positioned airtightly in an opening of the part of the building which opens to the outside of the building, in such a way that a first end of the duct opens to the inside of the part of the building and the second end of the duct opens to the outside of the building, and all the other openings of the part of the building which open to the outside of the building are shut off;
the motorized fan is switched on;
the shut-off member is adjusted into its configuration of complete shutting-off of the duct and a check is carried out to ensure that the measured pressure difference between the inside of the part of the building and the outside of the building is substantially zero;
the shut-off member is operated, from its configuration of complete shutting-off of the duct, gradually toward its configuration of minimal shutting-off of the duct, until a measured pressure difference value is reached that is equal to the reference pressure difference;
either the air flow rate through the duct is determined, or a parameter representative of the air permeability of the part of the building is determined, using said means for determining the degree of shutting-off for the reference pressure difference and said means for determining, from the degree of shutting-off for the reference pressure difference, either the corresponding air flow rate in the duct or a parameter representative of the air permeability of the part of the building.

The features and advantages of the invention will become further apparent from the following description of one embodiment of a device and of a method for measuring permeability according to the invention, which is given solely by way of example and made with reference to the attached drawings in which:

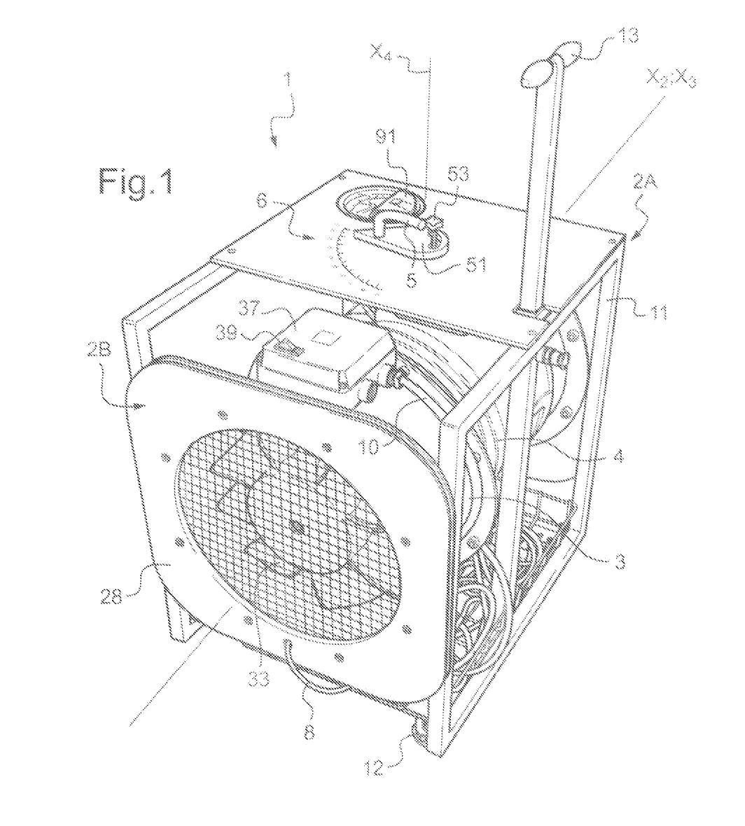

FIG. 1 is a perspective view of a device for measuring permeability according to the invention;

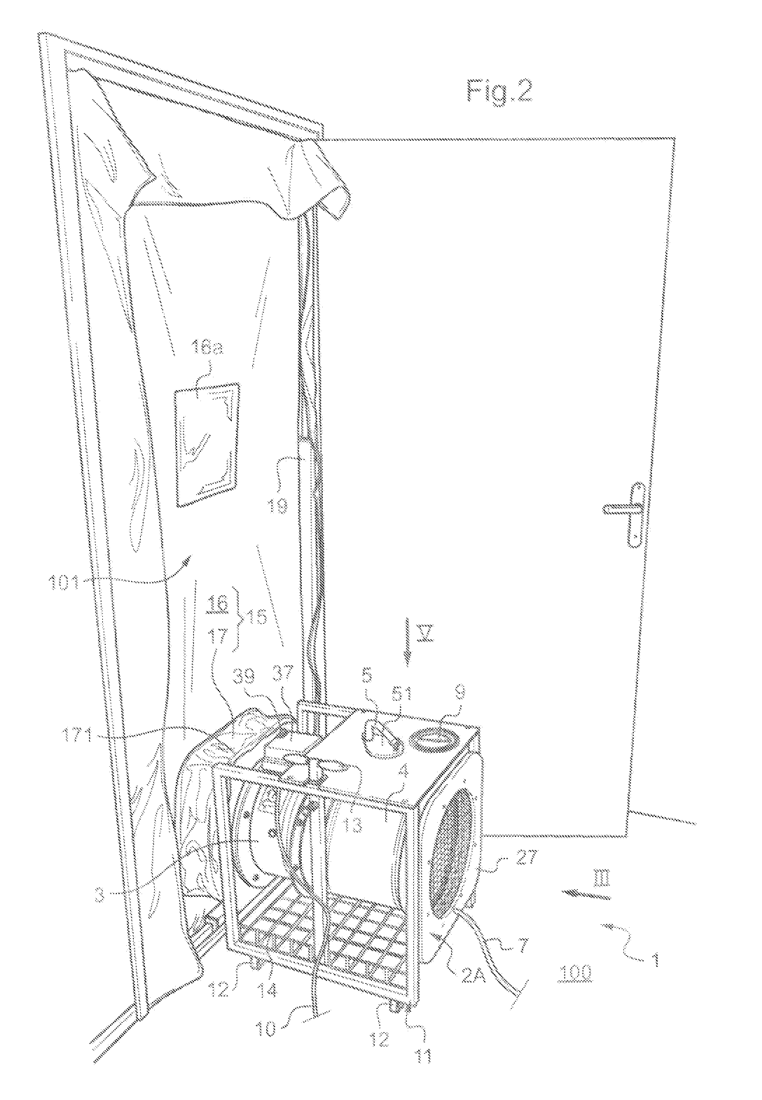

FIG. 2 is a perspective view of the device of FIG. 1 set in place in an opening of a premises, the air permeability of which is to be measured, the device being viewed from inside the building;

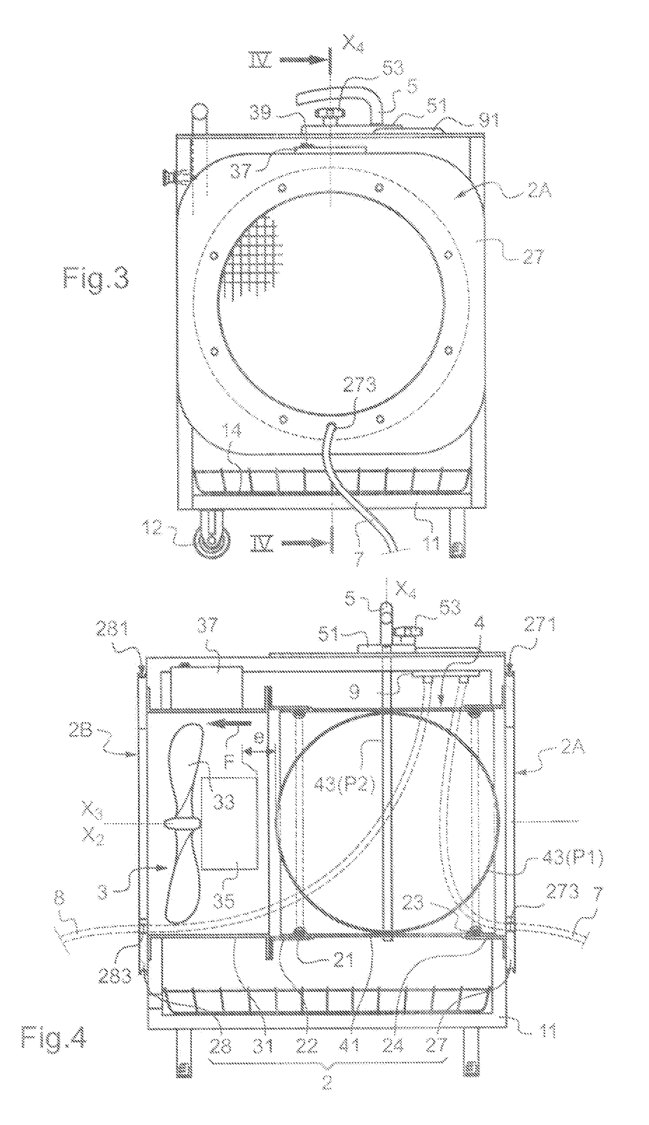

FIG. 3 is a view of the device in the direction of arrow III of FIG. 2;

FIG. 4 is a cross section along line IV-IV of FIG. 3;

FIG. 5 is a view of the device in the direction of arrow V of FIG. 2;

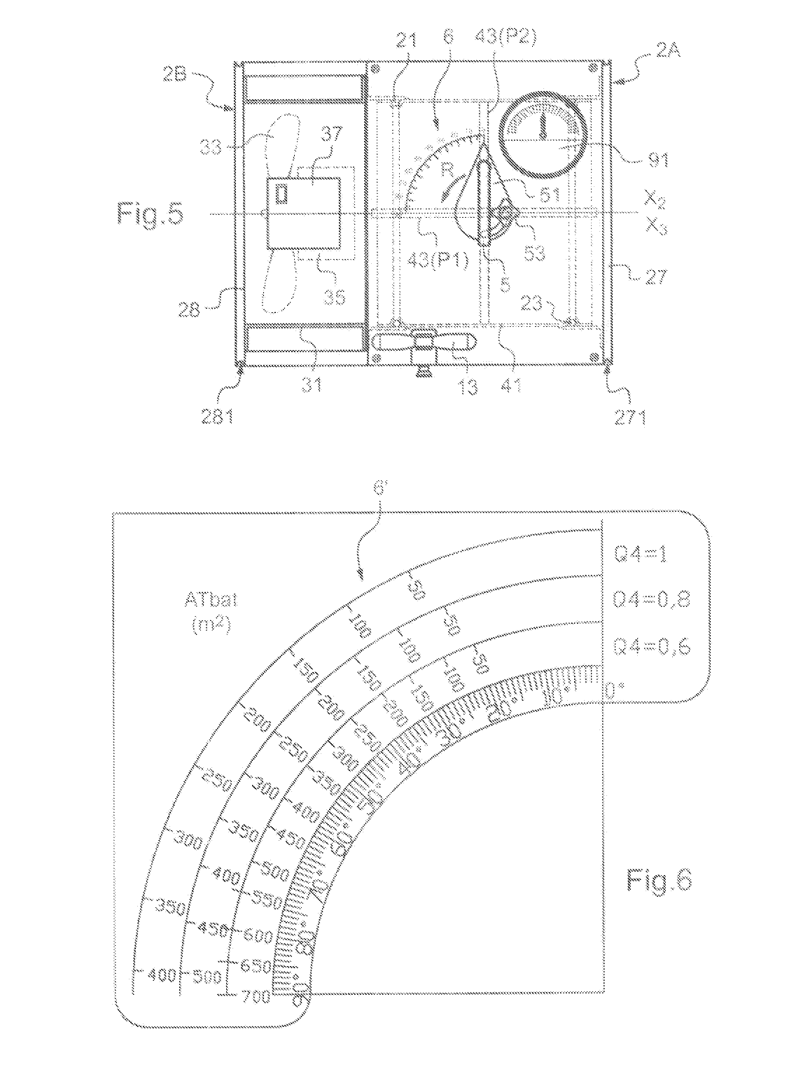

FIG. 6 is a chart that forms part of the device of FIG. 1;

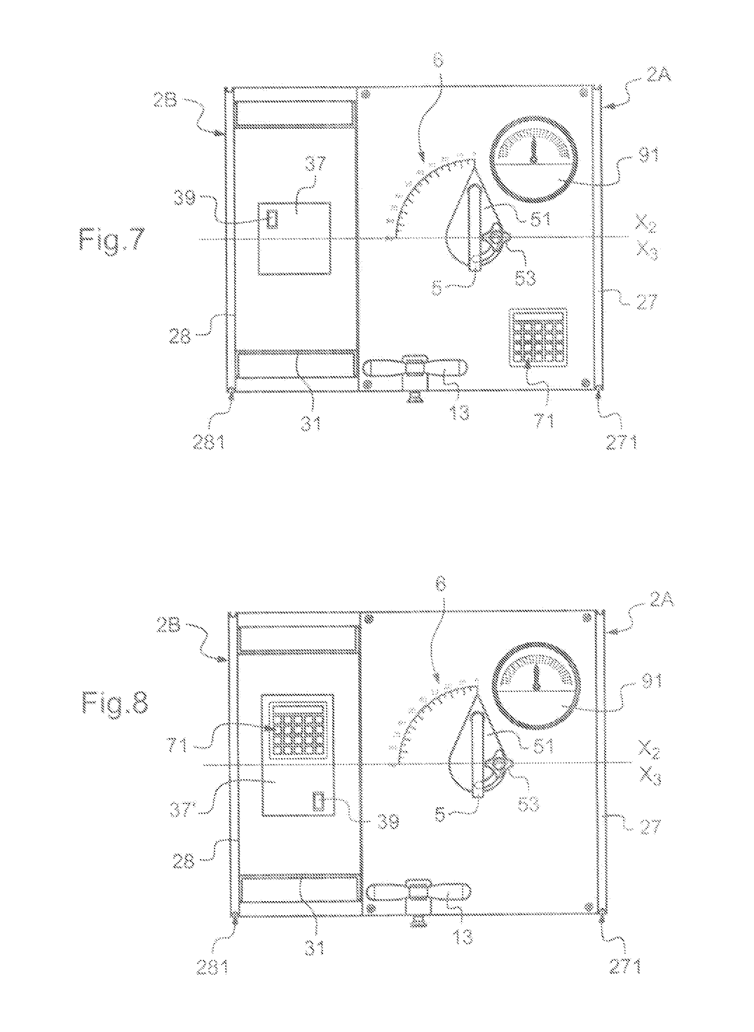

FIG. 7 is a view similar to FIG. 5 for an alternative form of the device for measuring permeability; and

FIG. 8 is a view similar to FIG. 5 for another alternative form of the device for measuring permeability.

The device 1 depicted in FIGS. 1 to 5 is intended for measuring the air permeability of a premises, corresponding to all or part of a building. In particular, isolated rooms of a building may be measured separately using the device 1. For example, in an apartment building, each apartment may be measured separately.

The device 1 comprises an airtight duct 2 centered on a longitudinal axis X₂, which is formed of a succession of several duct sections joined together. As is clearly visible in the cross section of FIG. 4, one of the sections of the duct 2 is formed of a collar 31 of a motorized fan 3, which is centered on the axis X₂ and inside which there are a propeller 33 and a motor 35 of the motorized fan. The propeller 33, which allows air to be drawn in in the direction of the arrow F in FIG. 4, is positioned in the duct 2 with its axis of rotation X₃ coinciding with the longitudinal axis X₂ of the duct. The motorized fan 3 also comprises a terminal block 37 which carries a switch 39 for switching on the motorized fan and to which an electric power lead 10 for the motorized fan is connected. In an alternative form that has not been depicted, the motor of the motorized fan may be relocated to the external periphery of the collar, for example near the terminal block 37, making it possible to improve compactness in the direction of the longitudinal axis X₂. For preference, the motor 35 of the motorized fan has no speed variator.

The motorized fan 3 is designed to generate a mechanical pressurizing or depressurizing of the premises, the permeability of which is to be measured. To do so, the motorized fan 3 is chosen to have a maximum flow rate suited to the type of premises, the airtightness of which is to be measured, and in particular, the greater the volume of the premises, the higher the maximum flow rate of the motorized fan will need to be. By way of example, for individual dwellings or small buildings, an appropriate value for the maximum flow rate of the motorized fan 3 is of the order of 1750 m³/h at 50 Pa.

Another section of the duct 2, positioned upstream of the section 31 when considering the direction F in which the air flows through the motorized fan 3, is formed by the cylindrical body 41 of a damper 4. The body 41 is centered on the longitudinal axis X₂ of the duct. A disk-shaped flap 43 is arranged inside the body 41. This flap 43 is mounted so as to pivot in the body 41 about an axis X₄ perpendicular to the longitudinal axis X₂ of the duct, where the pivot axis X₄ extends along a diameter of the pivoting flap 43.

To operate the pivoting of the pivoting flap 43 about the axis X₄ from outside the body 41, the device 1 comprises a knob 5, clearly visible in FIG. 5, which is secured to the pivot axis X₄ of the pivoting flap.

The pivoting flap 43 is adjustable, by means of the knob 5, between a position P1 of minimal shutting-off of the duct 2, in which position it is oriented parallel to the longitudinal axis X₂, and a position P2 of complete shutting-off of the duct 2, in which position it is oriented perpendicular to the longitudinal axis X₂. The pivoting flap 43 is thus able to vary locally the cross section for air flow through the duct 2 upstream of the propeller 33 of the motorized fan 3.

Advantageously, as the pivot axis X₄ extends along a diameter of the pivoting flap 43, this variation in cross section occurs symmetrically with respect to the axis of rotation X₃ of the propeller 33. Such an arrangement, which respects the axial symmetry of the device, makes it possible to keep the air flow stable in the duct 2 as the pivoting flap 43 pivots.

As may be seen in FIG. 4, the distance e, taken parallel to the longitudinal axis X₂ of the duct, between the motorized fan 3 and the pivoting flap 43, when the latter is in its position P1 of minimal shutting-off, is minimized. That makes it possible to limit the size of the device 1 in the direction of the axis X₂.

The knob 5 comprises a part 51 in the form of a pointer which, as the pivoting flap 43 is made to pivot, moves past a graduation 6 provided for that purpose on a casing of the device. The graduation 6 may, for example, be obtained by attaching to the casing a sticker that bears the graduation. The graduation 6 makes it possible to determine visually, according to the position of the knob 5, the degree to which the duct 2 is shut off by the pivoting flap 43, which degree of shutting-off is represented by the angle of pivoting of the pivoting flap 43, which is between 0° and 90°.

When the part 51 of the knob 5 is marking an angle of 0° on the graduation 6, the pivoting flap 43 is in its position P2 of complete shutting-off of the duct 2. When the part 51 of the knob 5 is marking an angle of 90° on the graduation 6, the pivoting flap 43 is in its position P1 of minimal shutting-off of the duct 2. The two positions P1 and P2 of the pivoting flap 43 are shown in dotted line in FIG. 5, it being understood that the position of the knob 5 in this figure corresponds to the position P2. The knob 5 also comprises a pin 53 allowing the knob, and therefore the pivoting of the pivoting flap 43, to be blocked.

The body 41 of the damper 4 is assembled, at each of its two ends, with a stepped collar 22 or 24 allowing connection to adjacent duct sections. Each collar 22 or 24 is assembled to the corresponding end of the body 41 in a way that is rendered airtight by the presence of an O-ring seal 21 or 23 on the external periphery of the body 41.

The collar 22 situated downstream of the body 41 is assembled with the collar 31 of the motorized fan 3, by joining at their respective shoulders. The surface-to-surface contact between the shoulders of the two collars 22 and 31 ensures that the assembly is airtight.

The collar 24 situated upstream of the body 41 and the collar 31 of the motorized fan 3 are each connected to an end plate, 27 and 28 respectively, each partially made of mesh, by securing a shoulder of the collar to a solid part of the end plate in each instance. Once again, the surface-to-surface contact between the shoulder and the solid part of the end plate ensures that the assembly is airtight.

The end plates 27 and 28 form the end sections of the duct 2. The two ends 2A and 2B of the duct 2, which are respectively situated one upstream and one downstream of the propeller 33 of the motorized fan 3 when considering the direction F in which the air flows therethrough, are open thanks to the mesh part of each end plate 27 and 28.

If a premises, the airtightness of which is to be measured, is to be subjected to a depressurization, the duct 2 needs to be positioned airtightly in an opening of the premises that opens to the outside of the building, with the upstream end 2A opening to the inside of the premises and the downstream end 2B opening to the outside of the premises, and all the other openings of the premises that open to the outside of the building need to be shut off. Such a configuration is illustrated in FIG. 2 in which the device 1 has been installed in a door opening 101 of a premises 100, so as to measure the air permeability of the premises 100 using depressurization testing.

Conversely, if the premises, the airtightness of which is to be measured, is to be pressurized, the duct 2 needs to be positioned with the downstream end 2B opening to the inside of the premises and the upstream end 2A opening to the outside of the premises.

The device 1 also comprises a differential pressure gauge 9 for measuring the pressure difference ΔP between the inside of the premises the airtightness of which is to be measured and the outside of the building. The pressure gauge 9 is chosen to have a precision that allows pressure differences to be measured to within ±2 Pa within the range from 0 Pa to 60 Pa. In this embodiment, the pressure gauge 9 has an analog display. As an alternative, it is possible to use an electronic pressure gauge. However, an analog pressure gauge is preferable because of its robustness and ease of use. In particular, an analog pressure gauge requires no calibration.

As can be clearly seen in FIG. 5, the pressure gauge 9 is fixed to the outside of the duct 2, with its dial 91 located near the knob 5 that operates the pivoting flap 43. Two flexible air intake pipes 7 and 8, one for air intake inside the premises and one for air intake outside the premises, are connected to the inlets of the pressure gauge 9, as shown schematically in FIG. 4.

In order to group the various constituent parts of the device into a minimum volume, the device 1 comprises a chassis 11 on which the end plates 27 and 28 of the duct 2 and the pressure gauge 9 are fixed. More specifically, as can be seen in FIG. 1, the end plates 27 and 28 are fixed to two opposite sides of the chassis 11, while the pressure gauge is fixed to a cover of the chassis 11, near the knob 5 that operates the pivoting flap 43. The chassis 11 is fitted with wheels 12 and with a handle 13 to make the device 1 easy to manipulate and to move around, particularly by a single operator. The chassis 11 also comprises a basket 14, situated underneath the duct 2, in which the air intake pipes 7 and 8 can advantageously be folded up when the device 1 is not in use for permeability measurement.

In order to avoid any confusion between the two air intake pipes 7 and 8 and in order to avoid any handling errors, each pipe fits through an orifice in one of the two end plates 27 and 28, and is gripped in this orifice by static friction. Thus, as shown schematically in FIG. 4, the pipe 7 connected to the “low-pressure” side of the pressure gauge 9 passes through an orifice 273 of the end plate 27 situated on the upstream side, while the pipe 8 connected to the “high-pressure” side of the pressure gauge 9 passes through an orifice 283 of the end plate 28 situated on the downstream side, again considering the direction F in which the air flows through the motorized fan 3.

The device also comprises, as may be seen in FIG. 2, a panel 15 designed to be fixed airtightly and removably, by means of a mounting frame 19, into an opening of a premises, the airtightness of which is to be measured using the device 1. The aforementioned opening needs to be connected to the outside of the building. This may, in particular, be a door opening such as the opening 101 of the premises 100.

The panel 15 comprises a flexible and airtight membrane 16 which is equipped with a transparent porthole 16a in accordance with the relevant standards. By way of nonlimiting example, the membrane 16 may be formed by a VARIO DUPLEX membrane marketed by Saint-Gobain Isover, in which the porthole 16a has been formed. The panel 15 also comprises an airtight sleeve 17, advantageously made of resin-impregnated fabric, which is sewn to the membrane 16. The sleeve 17 is provided, near its free end, with an elastic 171 which extends all around its contour. This elastic 171 can be housed in two grooves 271 and 281 formed respectively on the external periphery of the end plate 27 and on the external periphery of the end plate 28 of the duct 2, in order to provide airtight cooperation between the duct 2 and the sleeve 17.

The frame 19 designed for the airtight mounting of the panel 15 into an opening is a frame of adjustable size, made up of a plurality of aluminum section pieces. This type of frame is well known and in common use for measuring the air permeability of buildings. In the known way, the section pieces of the frame 19 can be clipped together to form the two uprights and the two cross-members of the frame. A central frame cross-member, not depicted in FIG. 2, may be advantageously provided in addition to the two, upper and lower, cross-members, in order to avoid any deformation of the membrane near the ventilation equipment when the duct 2 is in place in the sleeve 17.

In the known way, a system of cams allows the dimensions of the frame 19 to be adjusted to fit into the framing of the opening. When it is fixed into the opening, the membrane 16 of the panel 15 is compressed between the framing of the opening and the section pieces that form the contour of the frame 19. To make it easier to hold the panel 15 in position with respect to the frame 19 on mounting, Velcro tapes are provided on the membrane 16.

Advantageously, the panel 15 and the frame 19 may respectively be folded and dismantled so as to occupy a minimum amount of space. In particular, the panel 15 once folded can be housed in the basket 14 of the chassis. The entire device 1 is thus easy to manipulate and move around, particularly by a single operator.

A method for measuring the air permeability of a premises, corresponding to all or part of a building, by means of the device 1 according to the invention, will now be described.

First of all, it is noted that such a measurement method may involve either depressurizing or pressurizing the premises the airtightness of which is to be measured. In what follows, an example of a depressurization measurement test of the premises is described. It is also noted that the premises the airtightness of which is to be measured needs to be configured in such a way as to react to the pressurizing or the depressurizing as a single zone. In particular, all the internal communicating doors inside the premises need to be open in order to maintain uniform pressure.

By way of example, a method for measuring the air permeability of the premises 100 in FIG. 2 using the device 1 comprises steps as described below.

First, all the internal communicating doors inside the premises 100 are open and all the openings of the premises 100 that are open to the outside of the building are shut off, with the exception of the door opening 101.

The panel 15 is then installed airtightly in the door opening 101 using the mounting frame 19. To do that, for example, the membrane 16 of the panel 15 can be spread out on the ground and the frame 19, obtained by assembling its various constituent section pieces, can be fixed to the surface of the membrane 16 using the Velcro tapes provided for that purpose. The membrane 16 equipped with the frame 19 is then positioned in the framing of the opening 101, and the size of the uprights and cross-members of the frame 19 is adjusted in order to secure the membrane 16 airtightly between the frame 19 and the framing of the opening 101.

The internal and external pressure intake pipes 7 and 8 are then unwound and placed one on each side of the opening 101, at a certain distance, preferably at a distance of several meters, away from the ventilation equipment.

The duct 2 is then positioned in the sleeve 17 of the panel 15 such that the upstream end 2A of the duct opens to the inside of the premises 100 and the downstream end 2B of the duct opens to the outside of the building. To guarantee the airtightness of the connection between the sleeve 17 and the duct 2, it should be ensured that the elastic 171 of the sleeve is correctly engaged in the peripheral groove 281 of the end plate 28.

Airtightness between the sleeve 17 and the duct 2 can be obtained only if the air intake pipes 7 and 8 are correctly positioned, namely the pipe 7 inside the premises and the pipe 8 outside the building. Specifically, because each of the two pipes comes from an orifice 273 or 283 pierced in one of the two end plates 27 and 28 of the duct, the two pipes are held on either side of the peripheral groove 281. This means that any incorrect positioning of the pipes, i.e. any inverted positioning of the pipes, with the pipe 7 outside the building and the pipe 8 inside the premises 100, or any positioning of the pipes in which they are both on the same side, prevent the elastic 171 of the sleeve from engaging in the groove 281 of the duct. This arrangement acts as an errorproofing feature, limiting the risk of incorrect use of the device 1.

The motorized fan 3 is then switched on, using the switch 39, and the pivoting flap 43 is placed in its position P2 of complete shutting-off of the duct 2, using the knob 5. In this configuration, a check is carried out to ensure that the pressure difference ΔP measured by the pressure gauge 9 between the inside of the premises 100 and the outside of the building is substantially zero, to within ±2 Pa, for a duration of at least 30 seconds.

Once this check has been made, the pivoting flap 43 is gradually opened, from the position P2 of complete shutting-off, by a gradual pivoting of the pivoting flap 43 about the axis X₄ toward its position P1 of minimal shutting-off. To do so, the knob 5 is turned progressively in the direction of the arrow R in FIG. 5. In so doing, the pressure difference ΔP between the inside of the part of the premises 100 and the outside of the building is varied until a reference pressure difference ΔPᵣ of 50 Pa is reached, this pressure difference being read off the dial 91 of the pressure gauge 9. The pivoting flap 43 is opened progressively, in order to allow the air flow rate to stabilize for each pressure difference.

When the reference pressure difference ΔPᵣ of 50 Pa is reached, the corresponding value of the degree of shutting-off is determined visually using that part 51 of the knob 5 which points to a value on the graduation 6. Charts, such as the chart 6′ depicted in FIG. 6, are then used to deduce the value of a parameter representative of the air permeability of the premises 100.

The chart 6′ establishes, for the reference pressure difference ΔPᵣ=50 Pa, a relationship between:
the degree of shutting-off of the duct 2 by the pivoting flap 43, which is represented by the angle of pivoting of the flap 43 comprised between 0° and 90° on the chart 6′,
the total surface area of cold walls A_{PF} of the premises, which is denoted A_{Tbat} and given in m² on the chart 6′, and
the leakage flow rate at 4 Pa divided by the surface area of cold walls

$${Q}_{4 Pa - surf} = \frac{V 4}{{A}_{PF}} ,$$

denoted Q4 and given in m³/(h·m²) on the chart 6′.

For the BBC-Effinergie label, the value of the indicator Q_{4Pa-surf} needs to be less than or equal to 0.6 m³/(h·m²). Using the chart 6′, it is possible to determine directly whether the value of the indicator Q_{4Pa-surf} of the premises 100 is satisfactory: starting from the degree of shutting-off read opposite the tip of the part 51 of the knob, and knowing the total surface area of cold walls of the premises 100, a visual check is carried out to determine whether the premises falls within the band labeled Q4=0.6 on the chart 6′.

In practice, the chart 6′, or any other chart used for visually determining, from the degree of shutting-off corresponding to the reference pressure difference ΔPᵣ=50 Pa, either the corresponding air flow rate in the duct 2, or a parameter representative of the air permeability of the premises, is obtained by carrying out a laboratory calibration of the device 1. This calibration makes it possible to establish the relationship between the degree of shutting-off at the reference pressure of 50 Pa and the corresponding volumetric air flow rate in the duct 2, denoted V50.

In a known way, the volumetric air flow rate through an airtightness defect, or leakage flow rate, denoted V, is given by the equation:

V=C(ΔP)ⁿ (I),

where C is the air permeability coefficient, ΔP is the pressure difference on either side of the envelope, and n is the exponent of the flow. In particular, it has been found empirically that the value of the exponent n is always comprised between 0.6 and 0.7 for new-build individual houses.

From equation (I) it is possible to deduce that the ratio of the leakage flow rate at 4 Pa to the leakage flow rate at 50 Pa is given by the expression:

$$\frac{V 4}{V 50} = {( \frac{4}{50} )}^{n} , \qquad ( II )$$

from which it is possible to deduce an expression for the indicator Q_{4Pa-surf} as a function of the volumetric flow rate V50:

$$\begin{matrix}{Q}_{4 P a - surf} = \frac{V 4}{{A}_{PF}} \\ = {( \frac{4}{50} )}^{n} \frac{V 50}{{A}_{PF}} .\end{matrix} \qquad ( III )$$

In expression (III) above, the volumetric flow rate V50 is directly related to the degree of shutting-off of the duct 2 by the pivoting flap 43 as determined visually by the part 51 of the knob 5; the total surface area of cold walls A_{PF} of the premises is known; and the value of the exponent n can be evaluated empirically for each type of premises, particularly when the premises is a new-build individual house, a value of the exponent n of 0.6 can be adopted, this being the most penalizing value.

Thus, in the light of the foregoing, it is possible to plot parameterized charts which establish, for the reference pressure difference ΔP, a relationship between the degree of shutting-off, the surface area of cold walls A_{PF} and the indicator Q_{4Pa-surf}, as shown by the chart 6′ in FIG. 6.

In this example, the chart 6′ makes it possible to determine the leakage flow rate at 4 Pa divided by the surface area of cold walls, Q_{4Pa-surf}, which is used notably for the BBC-Effinergie label. As a variant, the device according to the invention may comprise, instead of or in addition to a chart for determining Q_{4Pa-surf}, charts for determining other parameters representative of the air permeability, such as the leakage flow rate at 50 Pa divided by the heated volume, n₅₀=V50/V_{heated}(IV), which is used notably for the Passivhaus or Minergie-P labels.

In addition, instead of or in addition to charts, the device according to the invention may comprise a calculation unit programmed with an algorithm which uses, for one or for each of a number of parameters representative of the air permeability such as the parameters Q_{4Pa-surf} and n₅₀, an equation that expresses the parameter representative of the air permeability as a function of input data that are to be provided by a user. One of the input data to be provided for the algorithm is either the degree of shutting-off of the duct 2 by the pivoting flap 43, or directly the corresponding volumetric flow rate V50, the value of which is known from calibration. The calculation unit is built on a conventional programmable computer capable of executing instructions recorded on a data recording medium.

By way of example, the calculation unit can be programmed with an algorithm that uses equation (III) above expressing the indicator Q_{4Pa-surf}, in which the exponent n is taken equal to 0.6, i.e. the most penalizing value. The input data to be provided for the algorithm are then: —the surface area of cold walls A_{PF} of the premises, and —either the degree of shutting-off of the duct 2 by the pivoting flap 43, or directly the corresponding volumetric flow rate V50. The calculation unit is designed to supply, at output, the value of the parameter Q_{4Pa-surf}.

According to another example, the calculation unit can be programmed with an algorithm which uses equation (IV) above expressing the indicator n₅₀. The input data to be provided for the algorithm are then: —the heated volume of the premises, and —either the degree of shutting-off of the duct 2 by the pivoting flap 43, or directly the corresponding volumetric flow rate V50, the calculation unit being designed to supply, at output, the value of the parameter n₅₀.

The input data to be supplied for the algorithm may also comprise a target maximum permissible value for the parameter representative of the air permeability, this maximum permissible value for example being defined by a standard. The calculation unit can then be designed to provide, at output, a message of the OK/NOK type indicating whether the calculated value of the parameter representative of the air permeability is indeed below or equal to the target maximum permissible value.

FIGS. 7 and 8 illustrate two alternative forms of the device 1, in which a computer 71 as mentioned hereinabove, of the programmable computer type, is incorporated onto the cover of the device near the knob 5 for operating the pivoting of the flap 43. In the usual way, the computer 71 comprises a display screen and a keypad. In the alternative form of FIG. 7, the computer 71 is placed directly on the cover of the device with a hole therein. In the alternative form of FIG. 8, the computer 71 is arranged in a casing 37′, which replaces the terminal block 37 of the embodiment of FIG. 5 and which combines the computer 71, the switch 39 for switching on the motorized fan and the electrical power supply for the motorized fan.

The previous example considered the special case of a measurement method involving depressurizing the premises 100. A measurement method involving pressurizing the premises can also be carried out using the device 1. To do that, the elastic 171 of the sleeve 17 is made to cooperate with the groove 271, instead of the groove 281 as in FIG. 2, i.e. the device is inverted so that the upstream end 2A of the duct opens to the outside of the building and the downstream end 2B of the duct opens to the inside of the premises 100. Thus, the device 1 is readily reversible.

As is evident from the foregoing, a device according to the invention has numerous advantages: its simplicity and its speed of use; the fact that it is portable and can be installed by a single operator; the fact that it is optimized in terms of weight, size, number of components and therefore cost price; its improved robustness over devices of the prior art, particularly obtained by limiting the presence of electronic equipment, or even because of the complete absence of electronic equipment as in the embodiment of FIGS. 1 to 6; the fact that it is a stand-alone device, since no additional computer or graphic interface is required in order to determine the value of a parameter representative of the air permeability; the fact that it is reversible, which means that it can perform both pressurization measurement testing and depressurization measurement testing of the premises simply by inverting the duct of the device.

The invention is not restricted to the embodiments described and depicted.

In particular, the pivoting flap 43 may be replaced by any type of shut-off member, notably by a diaphragm centered on the longitudinal axis of the duct, or alternatively by a valve with a rounded head able to slide in relation to a corresponding seat parallel to the longitudinal axis of the duct. For preference, the shut-off member is chosen so that the variation in cross section resulting from it being operated between the configuration of minimal shutting-off and the configuration of complete shutting-off does not break the axial symmetry of the duct.

In addition, in order to vary locally the cross section for air flow through the duct of the device, and therefore the air flow rate through the duct, the shut-off member may, according to the invention, be positioned in the duct either upstream or downstream of the air induction member of the motorized fan. In particular, in the previous example, the pivoting flap could be situated in the duct 2 downstream of the propeller 33 of the motorized fan 3, when considering the direction F in which air flows through the motorized fan 3, rather than be situated upstream of the propeller 33.

Moreover, the means for determining the degree of shutting-off of the duct by the shut-off member for the reference pressure difference may comprise, instead of a knob as in the previous examples, an electronic sensor for measuring the degree of shutting-off, which is arranged in the duct, particularly an electronic angle sensor when the shut-off member is a pivoting flap.

The operation of the adjustment of the shut-off member in order to vary the cross section for air flow through the duct, particularly the operation of the pivoting of the pivoting flap 43 in the embodiment shown in the figures, can also be achieved in an automated manner using an electronic device, rather than being performed by hand. The means for determining the degree of shutting-off associated with such an automated system for operating the adjustment of the shut-off member can then be visual means or equivalent means, notably a slider which, when the shut-off member is adjusted, moves past a graduation, or means of the electronic sensor type for measuring the degree of shutting-off, as mentioned earlier.

The materials of which the various elements of the duct of the device are made may also vary in nature, provided that they are airtight. In particular, the duct sections 22, 24, 27, 28, 31 and 41 may be made of metal, for example of aluminum or galvanized steel, or may be made of an airtight resin.

Moreover, a chart of the type of the chart 6′ may be affixed directly to the cover of the device, facing the pointer-shaped part of the knob for actuating the shut-off member, in place of the graduation 6. That avoids the need to resort to paper charts.

Finally, the device according to the invention can be installed in any type of opening that opens to the outside of the building, particularly a door opening as in the above example, a window opening, or else an air outlet that connects the inside of the premises with the outside of the building.

1-22. (canceled)

23. A device for measuring air permeability of at least a part of a building, comprising:
an airtight duct, open at both its ends, a first end of the duct configured to open to an inside of the part of the building and a second end of the duct configured to open to an outside of the building;
a motorized fan including a rotary air induction member that is positioned in the duct with its axis of rotation substantially parallel to the longitudinal axis of the duct;
means for measuring pressure difference between the inside of the part of the building and the outside of the building;
an adjustable shut-off member for shutting off the duct, which is configured to vary locally a cross section for air flow through the duct, the shut-off member being continuously adjustable between a configuration of minimal shutting-off of the duct and a configuration of complete shutting-off of the duct; and
means for determining a degree to which the duct is shut off by the shut-off member for a reference pressure difference and means for determining, from the degree of shutting-off for the reference pressure difference, either a corresponding air flow rate through the duct, or a parameter representative of the air permeability of the part of the building.

24. The device as claimed in claim 23, wherein the shut-off member is configured to vary locally the cross section for air flow through the duct upstream of the air induction member of the motorized fan.

25. The device as claimed in claim 23, wherein the shut-off member is configured to vary locally the cross section for air flow through the duct downstream of the air induction member of the motorized fan.

26. The device as claimed in claim 23, wherein the means for determining the degree of shutting off of the duct for the reference pressure difference are visual means.

27. The device as claimed in claim 26, wherein the visual means for determining the degree of shutting-off for the reference pressure difference comprises, on an outside of the duct, a knob for operating the shut-off member between the configuration of minimal shutting-off and the configuration of complete shutting-off, the knob moving, upon adjustment, past a graduation.

28. The device as claimed in claim 23, wherein the means for determining the degree of shutting-off for the reference pressure difference comprises an electronic sensor measuring the degree of shutting-off, which is placed in the duct.

29. The device as claimed in claim 23, comprising means for determining a parameter representative of the air permeability of the part of the building from the degree of shutting-off for a reference pressure difference, which are visual means comprising at least one chart which, for the reference pressure difference, establishes a relationship between the degree to which the duct is shut off by the shut-off member, a dimension characteristic of the part of the building, and a parameter representative of the air permeability of the part of the building.

30. The device as claimed in claim 23, comprising means for determining the air flow rate from the degree of shutting-off for the reference pressure difference, and means for calculating a parameter representative of the air permeability of the part of the building from the air flow rate.

31. The device as claimed in claim 23, comprising means for determining the air flow rate from the degree of shutting-off for the reference pressure difference, which includes visual means comprising at least one chart which, for the reference pressure difference, establishes a relationship between the degree to which the duct is shut off by the shut-off member and the air flow rate through the duct.

32. The device as claimed in claim 23, wherein the shut-off member is configured to vary locally the cross section for air flow through the duct symmetrically with respect to the axis of rotation of the air induction member of the motorized fan.

33. The device as claimed in claim 23, wherein the shut-off member includes a pivoting flap placed in the duct and configured to pivot about an axis that is transverse to the longitudinal axis of the duct, between a position of minimal shutting-off of the duct and a position of complete shutting-off of the duct.

34. The device as claimed in claim 33, wherein in the position of minimal shutting-off of the duct, the pivoting flap is oriented substantially parallel to the longitudinal axis of the duct, while in the position of complete shutting-off of the duct, the pivoting flap is oriented transversely with respect to the longitudinal axis of the duct.

35. The device as claimed in claim 33, comprising a knob for operating the pivoting flap between the position of minimal shutting-off and the position of complete shutting-off, the knob being secured to the pivot axis of the pivoting flap.

36. The device as claimed in claim 23, wherein the shut-off member is a diaphragm of adjustable cross section arranged in the duct with the central axis of the diaphragm substantially parallel to the longitudinal axis of the duct.

37. The device as claimed in claim 23, wherein the motorized fan has no electronic speed variator.

38. The device as claimed in claim 23, wherein the means for measuring the pressure difference comprises a differential pressure gauge to which are connected first and second air intake pipes, the first for air intake inside the part of the building and the second for air intake outside the building.

39. The device as claimed in claim 23, comprising a panel that can be fixed, airtightly and removably, into an opening of the part of the building, the panel comprising a sleeve through which the duct passes.

40. The device as claimed in claim 39, comprising means of airtight cooperation between the sleeve and the duct, comprising an elastic of the sleeve that can be housed in an external peripheral groove of the duct.

41. The device as claimed in claim 40, comprising means for holding two air intake pipes, belonging to the pressure difference measurement means, on each side of the external peripheral groove of the duct.

42. The device as claimed in claim 39, comprising a frame for the airtight and removable attachment of the panel into an opening of the part of the building, the frame including a plurality of section pieces that can be joined together reversibly.

43. The device as claimed in claim 23, comprising a chassis for supporting the duct and means for measuring the pressure difference, the chassis including wheels.

44. A method for measuring air permeability of at least a part of a building using a device as claimed in claim 23, comprising:
positioning the duct airtightly in an opening in the part of the building, such that a first end of the duct opens to an inside of the part of the building and a second end of the duct opens to an outside of the building, and all other openings of the part of the building are shut off;
switching the motorized fan on;
adjusting the shut-off member into its configuration of complete shutting-off of the duct and carrying out a check to ensure that the measured pressure difference between the inside of the part of the building and the outside of the building is substantially zero;
operating the shut-off member, from its configuration of complete shutting-off of the duct, gradually toward its configuration of minimal shutting-off of the duct, until a measured value of the pressure difference is reached that is equal to the reference pressure difference;
determining either the air flow rate through the duct, or a parameter representative of the air permeability of the part of the building, using the means for determining degree of shutting-off for the reference pressure difference and the means for determining, from the degree of shutting-off for the reference pressure difference, either a corresponding air flow rate in the duct or a parameter representative of the air permeability of the part of the building.
